(19) United States
(12) Patent Application Publication
(10) Pub. No.: US 2012/0064942 A1
(43) Pub. Date: Mar. 15, 2012

(54) Method for the connection between a MMSIM card and an application

(75) Inventor: Gilles Ryan Pittarello, Aix Les Bains (FR)

(73) Assignee: MYRIAD GROUP AG, Zurich (CH)

(21) Appl. No.: 13/136,203

(22) Filed: Jul. 26, 2011

(30) Foreign Application Priority Data
Jul. 29, 2010 (FR) FR 10 562 54

(51) Int. Cl. H04M 1/00; H01R 43/00

(52) U.S. Cl. 455/550.1; 29/825

(57) ABSTRACT

A method for establishing, on a platform using the LINUX operating system, a connection between a server of an MMSIM card and an application (18) of the user space (16), the connection to the MMSIM card being ensured by a USB-IC interface of the core space (14), by creating an Ethernet-type interface (30) between a CDC/EEM communication module (32) of the core space (14) and the application (18) ensuring the communication from TCP/IP commands of the CDC-EEM class.

The method includes the implementation of a daemon (40) in the user space (16), ensuring as a background task the detection of events from the core space (14), and controlling the following steps:
loading a host USB stack in the core space (14) for later communication with the MMSIM card, and
creating and configuring the network interface (30) when the daemon (40) detects the physical connection of an MMSIM card.

This claims the benefit of French Patent Application FR 10 562 54, filed Jul. 29, 2010 and hereby incorporated by reference herein.

### BACKGROUND

The present invention relates to a method for establishing, on a platform using the LINUX operating system, a connection between a server of an MMSIM card and an application of the user space, the connection to the MMSIM card being ensured by a USB-IC interface of the core space, by creating an Ethernet-type interface between a CDC/EEM communication module of the core space and the application ensuring the communication from TCP/IP commands of the CDC-EEM class.

Mobile telephones include a card containing a microcontroller and memory and containing different user connection data. This card, commonly referred to as UICC for “Universal Integrated Circuit Card” is commonly referred to as a “SIM card.”

Today, so-called multimedia SIM cards commonly designated using the expression MMSIM are appearing. These cards integrate a web server and a mass storage memory, the connection to the telephone being ensured by a USB IC connection.

Even if these cards are specified, a connection should be established between the telephone and the card strictly speaking in the event the telephone uses an Android platform, specified by the company Google, as operating system.

### SUMMARY OF THE INVENTION

It is an object of the present invention to provide a mechanism and a means for establishing a connection between an MMSIM card and an Android application.

The present invention provides a method of the aforementioned type, characterized in that it includes the implementation of a daemon in the user space, ensuring as a background task the detection of events from the core space, and controlling the following steps:
loading a host USB stack in the core space for later communication with the MMSIM card, and
creating and configuring the network interface when the daemon detects the physical connection of an MMSIM card.

According to the specific embodiments, the method includes one or more of the following features:
the method includes controlling an accessory driver for the core space by the daemon, using a command inscribed in a NODE to ensure power for the MMSIM card;
the method includes the production by the daemon, of a command recorded in a NODE intended for an accessory driver of the core space stressing the production by the accessory driver of a specific UEVENT-type event representative of the physical connection of an MMSIM card;
the method includes the following steps:
producing, upon detection of the presence of a physically connected MMSIM card, a specific event UEVENT representative of the physical connection by an accessory driver of the core space;
implementing the creation and configuration of the network interface, under the control of the daemon only when the daemon detects this specific event UEVENT representative of said physical connection;
the method includes a step for establishing a core in router mode under the control of the daemon by implementing rules for translating network addresses upon receipt of an event UEVENT reporting that a new network interface has been created from the server of the MMSIM card.
The invention also relates to a wireless telephone including a means for implementing a method as described above.

### BRIEF DESCRIPTION OF THE DRAWINGS

The invention will be better understood upon reading the following description, provided solely as an example and done in reference to the drawings, in which:

FIG. 1 is a diagram illustrating the arrangement of the software and material means in a telephone, according to the invention;

FIG. 2 is a flowchart of the establishment of a connection between an application and an MMSIM.

### DETAILED DETAILED DESCRIPTION

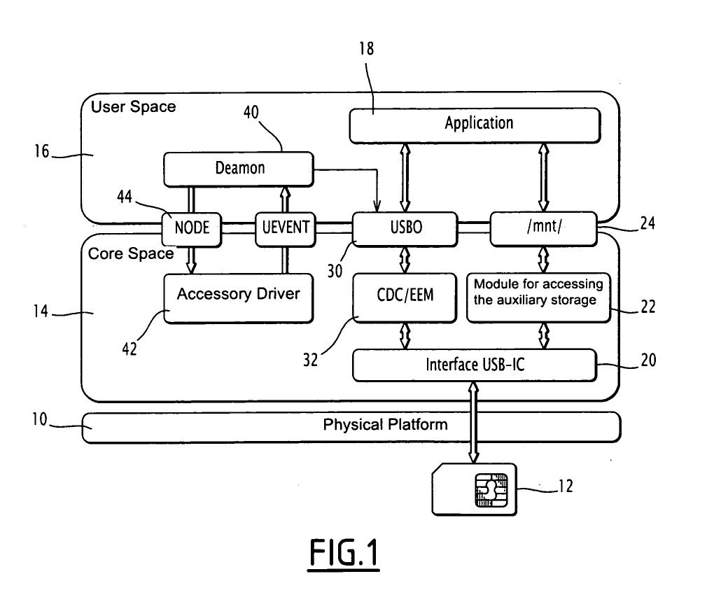

As illustrated in FIG. 1, the telephone according to the invention implements a physical structure 10, made up as known in itself of a processor, a memory adapted to save data and programs implemented by the processor, a means for communicating with a network, as well as a means for providing sound and visual information received by the telephone or available in it.

It also includes a multimedia SIM card 12, commonly designated by “MMSIM.” The mobile telephone is managed by an Android platform running LINUX whereof the core space 14 and the user space 16 are illustrated in FIG. 1. Applications 18 able to be implemented by the telephone, and intended to communicate with the MMSIM card 12, are present in the user space 16 of the Android platform.

The MMSIM card differs from SIM cards by the presence of a web server implementing the “OMA http” and “https” protocol, an auxiliary storage memory and a “USB IC High Speed Protocol” interface. This MMSIM card is managed by standards defined by the ETSI.

The MMSIM card includes a multimedia server known as “Smart Card Web Server” (SCWS) and a NAND memory area. This area is divided into two distinct regions.

The first area designated as “Secured Controlled Area” (SCA) implements the web server (SCWS) and is controlled by the operator to store data specific to the operator, such as web pages, customization information for the telephone or multimedia application data.

The second area, designated as “Host Controlled Area” (HCA), is controlled by the user and is used as an auxiliary storage area to receive user data such as movies, photographs, music, contact list, etc.

The SCWS multimedia server meets, for its communication, ETSI standard TS 102 483 and its access is made possible by the OMA5 standard.

The connection between the material structure of the telephone 10 and the MMSIM card 12 is done by a USB-IC (Universal Serial Bus Inter Chip) connection. The USB-IC standard is an evolution of the USB2.0 standard.

The USB-IC standard makes it possible to use APDU commands for the ICCD class elements to access the saved data corresponding to the 2G and 3G ETSI standard.

It also makes it possible to use the TCIP/IP protocol by using the “CDC/EEM” (Ethernet Emulation Model) class. It also allows direct access to the auxiliary storage for the files.

As illustrated in FIG. 1, an application 18 is intended to communicate with the second area HCA via a USB-IC interface denoted 20 and a module 22 for accessing the auxiliary storage contained in the core 14. The connection between the application 18 and the module 22, at the interface between the core and the user space, is done by an edit point 24, defining the path/mnt/.

For the connection between the first SCA area of the card 12 and an application 18, an interface 30 USB0 is created between the application 18 and a CDC/EEM communication module 32 ensuring the communication with the SCWS server of the card from TCP/IP commands of the CDC-EEM (Communications Device Class—Ethernet Emulation Model) class.

To establish this communication, through the Ethernet-type USB0 network interface, a daemon 40 is implemented on the Android platform so as to load, in the core space, the drivers or Linux accessory drivers adapted so the application 18 can address http or https requests to the SCWS server of the card 12.

The daemon 40 is for example written in C language and is implemented in the user space 16 of the Android software platform running Linux. The daemon 40 covers the solicitation of an accessory driver 42 to connect the MMSIM card 12 using the USB-IC interface. It is also responsible for creating the appropriate Ethernet network interface 30 called USB0 allowing the applications 18 to communicate with the server of the card 12.

In general, the daemon 40 communicates with the accessory driver 42. The latter is installed specifically in the core space 14.

For communication between the daemon 40 and the module 42, the daemon is able to use a specific command on a Linux NODE called proc/acc/route_vlsim to solicit the module 42 and use a mechanism UEVENT to allow the module 42 to provide information to the daemon 40. The command written in the NODE is specific for the creation of the USB-IC interface.

The daemon 40 is also able to detect, when a network interface is created for a PDP context allowing internet access. In that case, it turns the telephone into a router so that the SCWS server of the MMSIM card 12 can later exist in the local network and access the internet through the telephone.

The daemon 40 is activated each time the telephone is started up and ensures permanent oversight.

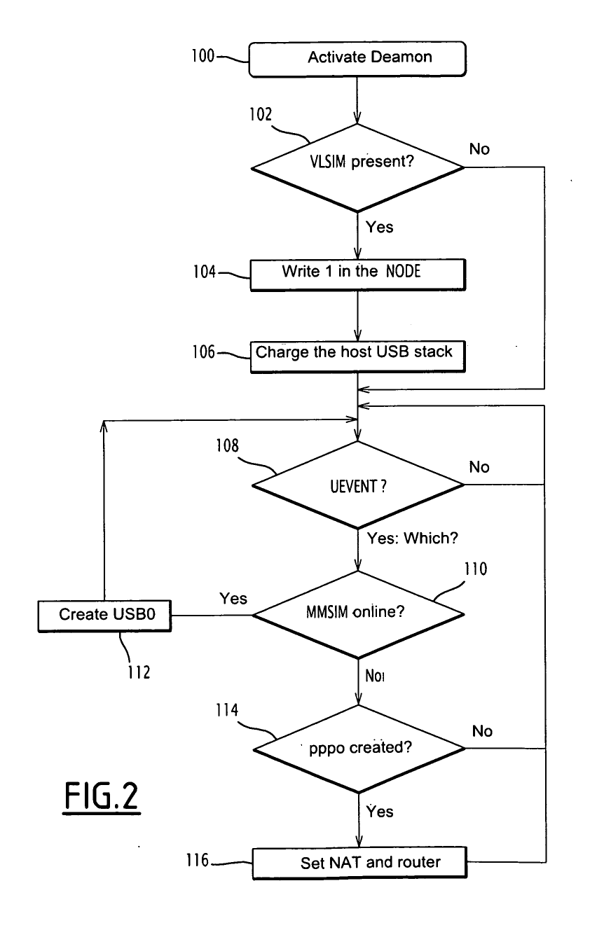

The connection mode with the MMSIM card 12 will now be described in light of FIG. 2.

After startup, in step 100 of the daemon, the latter looks for the presence of an empty file called vlsim in the directory/data/vlsim. This file and this directory are present by default in the telephone's file system. The presence of this file indicates that the telephone can manage an MMSIM card.

In step 102, the daemon 40 determines whether the file vlsim is present. If it is, the daemon writes a command in the NODE illustrated by reference 44 in FIG. 1. This command is written in the NODE proc/acc/route_vlsim.

In step 104, the value 0×01 is recorded in the node. In this way, the accessory driver 42 configures the power management unit to power the MMSIM card and multiplex it to connect the MMSIM card to the USB interface.

In step 106, the daemon 40 charges the host USB stack in the core space 14 for later communication with the MMSIM card. To that end, it executes the following command: insmod/system/lib/modules/ohci-hcd.ko.

If the file is absent in step 102, then steps 104 and 106 are omitted.

In step 108, accessory driver 42 waits for the return via the UEVENT mechanism.

When the physical platform 10 is connected to the SIM card 12, the accessory driver 42 creates the UEVENT called vlsim in indicating the “online” status. As a background task, the daemon 40 waits for such a UEVENT in its main loop and remains blocked as long as it does not receive any.

When the daemon detects the UEVENT vlsim in the “online” state in step 110, the daemon creates and configures the network interface 30, in step 112 so as to ensure the communication between the MMSIM card through the Ethernet on USB in class CDC-EEM. The name of the interface created is USB0 (interface 30 in FIG. 1). Its IP address is 192.168.0.2. The command used by the daemon to create this interface is: ifconfig usb0 192.168.000.002 netmask 255.255.255.000.

When the configuration of the network interface 30 is done, the daemon remains blocked on the RECV O function, in its main loop, while waiting for a new UEVENT.

At the end of these steps, the application 18 can send http or https requests to the SCWS server of the MMSIM card. The MMSIM card has address 192.168.0.1.

In order to allow the telephone to act as a router, the daemon 40 is able to place the core space 14 in a router mode when a pdp context is opened. To that end, the Linux core 14 comprises additional rules for translating network addresses, in particular making it possible to replace the IP address of the SCWS server with the IP address of the telephone during communications of the SCWS server on the network beyond the telephone. In particular, owing to the translation, the SCWS server of the MMSIM card sends, to access the internet, not its own network address but the public address of the telephone. Thus, the telephone is turned into a router for the server of the MMSIM card.

Thus, upon receipt of a UEVENT, if the latter does not correspond to “vlsim online” information in step 110 to allow the creation of a USB0 interface, a test is done in step 114 to determine a possible UEVENT ppp0 reporting that a new network interface has been created. On Android, the Internet interface of the browsing is still ppp0. When the ppp0 interface is detected in step 114, the daemon places the core 14 in router mode in step 116, by recording the value 1 in the NODE/proc/sys/inet/ipv4/ip_forward.

Moreover, it adds the rules for translating correct network addresses for the interface by the instruction iptables-t nat-A POSTROUTING -o ppp0 -j MASQUERADE.

One understands that the mode for creating an interface described here, is easy to implement, the presence of the daemon allowing an automatic recognition and an automatic connection between the telephone and the server of the MMSIM card.

What is claimed is:

1-6. (canceled)

7. A method for establishing, on a LINUX operating system platform, a connection between a server of an MMSIM card and an application of a user space, the connection to the MMSIM card being ensured by a USB-IC interface of a core space, by creating an Ethernet-type interface between a CDC/EEM communication module of the core space and the application to ensure communication from TCP/IP commands of the CDC-EEM class, the method comprising:
implementing a daemon in the user space, ensuring as a background task detection of events from the core space, and controlling the following steps:
loading a host USB stack in the core space for later communication with the MMSIM card, and
creating and configuring the network interface when the daemon detects a physical connection of the MMSIM card.

8. The method as recited in claim 7, further comprising, during a startup phase, controlling an accessory driver for the core space by the daemon, using a command inscribed in a NODE to ensure power for the MMSIM card.

9. The method as recited in claim 7 further comprising, during a startup phase, production by the daemon of a command recorded in a NODE intended for an accessory driver of the core space stressing the production by the accessory driver of a specific UEVENT-type event representative of the physical connection of an MMSIM card.

10. The method as recited in claim 7 further comprising:
producing, upon detection of the physically connected MMSIM card, a specific event UEVENT representative of the physical connection by an accessory driver of the core space; and
implementing the creation and configuration of the network interface, under the control of the daemon only when the daemon detects the specific event UEVENT representative of the physical connection.

11. The method as recited in claim 7 further comprising establishing the core in router mode under the control of the daemon by implementing rules for translating network addresses upon receipt of an event UEVENT reporting that a new network interface has been created from the server of the MMSIM card.

12. A wireless telephone comprising: means for implementing the method as recited in claim 7.

13. A wireless telephone comprising: a processor for implementing the method as recited in claim 7.
